(19) United States
(12) Patent Application Publication
(10) Pub. No.: US 2008/0183823 A1
(43) Pub. Date: Jul. 31, 2008

(54) Reply and Delete Function for Messaging System, Messaging System Including the Same, and Method of using the Same

(76) Inventor: Daniel Valencia, Rockville, MD (US)

Correspondence Address: Daniel Valencia, 10812 Antigua Terrace #103, Rockville, MD, 20852, US

(21) Appl. No.: 11/627,993

(22) Filed: Jan. 29, 2007

(51) Int. Cl. G06F 15/16

(52) U.S. Cl. 709/206

(57) ABSTRACT

The present invention is directed to a messaging system, including an electronic mail messaging application having a reply and delete function, and a data storage having an inbox associated with the electronic mail messaging application, the inbox having at least one email stored therein. The reply and delete function composes a reply message to the at least one email and deletes the at least one email from the inbox automatically when the reply message is sent.

### FIELD OF THE INVENTION

The present invention is directed to a reply and delete function for a messaging system, a messaging system including the same, and a method of using the same.

### BACKGROUND OF THE INVENTION

Messaging systems, such as email, are widely used all over the world. Typically, a user will receive various emails at an email account address and will check email with regular frequency.

Email message editors usually include various processing functions that can be performed on selected messages. For example, message editors may include a “forward” function that allows a user to forward the selected message to a recipient/destination address.

However, a common problem exists in conventional messaging editors of existing messaging systems in that messages tend to accumulate in a user's inbox. These messages take up space and cause the user the inconvenience of spending hours deleting past messages and organizing their inbox.

### SUMMARY OF THE INVENTION

The present invention provides a messaging system, including an electronic mail messaging application having a reply and delete function, and a data storage having an inbox associated with the electronic messaging application, the inbox having at least one email stored therein. The reply and delete function composes a reply message to the at least one email and deletes the at least one email from the inbox automatically when the reply message is sent.

The electronic mail messaging application may further include a reply function and a reply to all function. The data storage may be located at a server. The electronic mail messaging application may be an internet-based email application.

The messaging system may further include a client device having the electronic mail messaging application running thereon, and a server having the inbox with a plurality of messages.

The electronic mail messaging application enables a message to be selected from the inbox, enables the reply and delete function to be selected for the selected message, enables a reply message to be composed, and enables a send command to be selected to transmit the reply message and delete the selected message from the inbox.

The present invention also provides a messaging system, including a server in communication with at least one client, and an email application with at least one email stored in an inbox located on server. The email application may include a reply and delete function to compose a reply to a selected message and to delete the selected message automatically when the reply is sent.

The email application may be accessible via a web browser operating at the client. The email application may further include a reply function, a reply to all function, and a delete function.

The reply and delete function may be selectable to compose the reply to the selected message in the inbox, to enable the reply to be sent, and to delete the selected message from the inbox automatically when the reply is sent.

The present invention also provides a messaging system, including a client device in communication with a server, and a message editor running on the client device, the message editor providing instructions to the server and presenting a graphical user interface having a reply and delete function which creates a reply to a selected message and deletes the selected message upon transmission of the reply.

The message editor may include a web browser.

The message editor presents a first graphical user interface to enable selection of one of a plurality of messages, presents a second graphical user interface in response to the selection of the message to enable a selection of a processing function for the selected message, and presents a third graphical user interface in response to the selection of the processing function to enable a reply message to be composed when the selected processing function is a reply function, the third graphical user interface having a send function which is selectable to send the reply message and delete the selected message when the reply function is a reply and delete function.

### BRIEF DESCRIPTION OF THE DRAWINGS

FIG. 1 illustrates an option screen of a message editor according to an embodiment of the present invention;

FIG. 2 illustrates an option screen of a message editor according to another embodiment of the present invention;

FIG. 3 illustrates an editing screen of a message editor according to an embodiment of the present invention;

FIG. 4 illustrates a messaging system according to an embodiment of the present invention;

FIG. 5 illustrates a messaging system according to another embodiment of the present invention;

FIG. 6 illustrates a method of managing messages in a messaging system according to an embodiment of the present invention;

FIG. 7 illustrates a method of managing messages in a messaging system according to another embodiment of the present invention;

FIG. 8 illustrates a method of managing messages in a messaging system according to yet another embodiment of the present invention; and

FIG. 9 illustrates a method of using a replay and delete function according to an embodiment of the present invention.

### DETAILED DESCRIPTION OF THE INVENTION

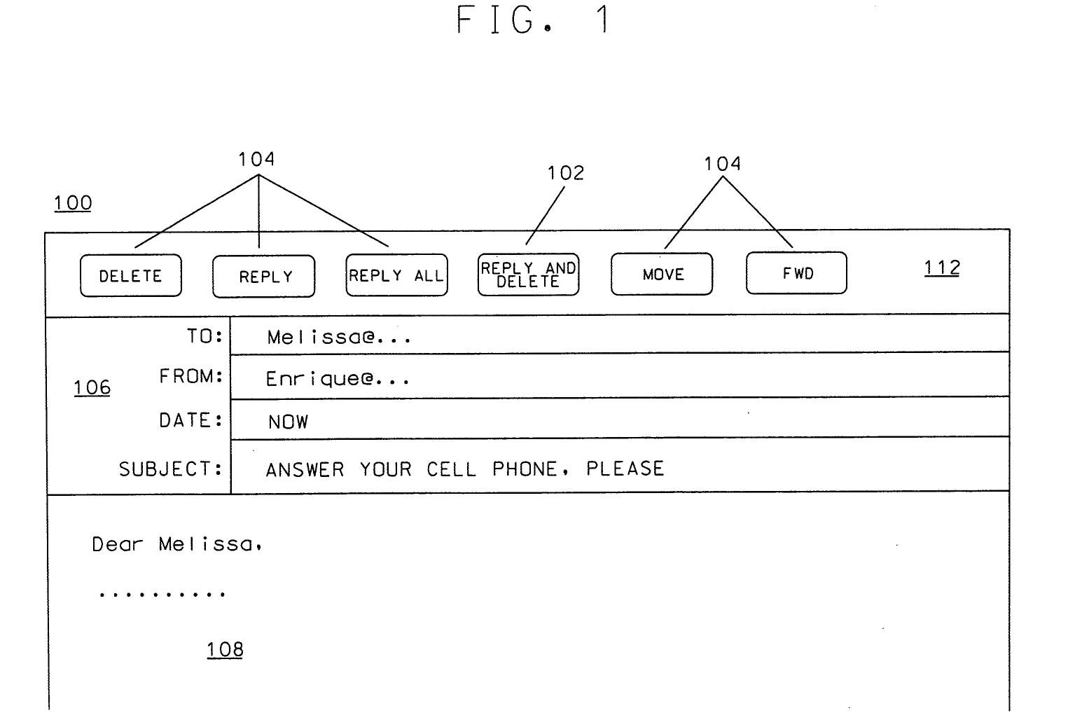

FIG. 1 illustrates an option screen 100 of a message editor according to an embodiment of the present invention. A user can select a message in an inbox. The selected message is then presented in the message editor 100.

As seen in FIG. 1, the option screen 100 of the message editor includes a graphical user interface (GUI) with a message body 108 having a message selected in an inbox, a message information panel 106 including information about the selected message, and a message processing panel 112. The option screen 100 may be displayed in response to a selection of the selected message.

The message information panel 106 includes TO, FROM, DATE, and SUBJECT information about the selected message. The message body 108 includes the body of the selected message 108.

The message processing panel 112 includes various message processing functions (buttons) 104 which can be selected by a user to issue message processing commands to the message editor 100. For example, these message processing functions 104 include a ‘delete’ function (button) that can be selected to delete the selected message, a ‘reply’ function (button) that can be selected to compose a reply to the selected message, a ‘reply all’ function (button) that can be selected to compose a reply to the selected message to be sent to all the recipients on the selected message, a ‘forward’ function (button) that can be selected to forward the selected message to another recipient, and a ‘move’ function (button) that can be selected to move the location of the selected message within the inbox.

The message processing panel 112 also includes a ‘reply and delete’ function (button) 102 that can be selected to compose a reply to the selected message and then automatically delete the selected message from the inbox upon transmission of the reply message. Similarly, although not shown, the message processing panel 112 may include a “forward and delete” function (button) that can be selected to compose a forward message including the selected message and then automatically delete the selected message from the inbox upon transmission of the forward message.

The reply and delete function 102 provides a single command that replies to a selected message and also deletes the selected message. Accordingly, a user need not select two different commands to accomplish both tasks.

In contrast with conventional messaging editors in which a user must first select a ‘reply’ function to reply to a selected message then go back and select a ‘delete’ function to delete the selected message, the option screen 100 of the messaging editor of the present embodiment enables the user to accomplish both tasks with a single command selection.

For users who typically receive messages and reply to messages, but do not immediately delete the messages to which they reply, the reply and delete function 102 of the present embodiment provides the user an alternative to going back and deleting messages that have accumulated in their inbox over an extended period of time. In some cases, a user may have hundreds of old and unimportant emails in their inbox that remain in the inbox after a reply has been sent simply because the user does not feel the need to go back and delete a message after replying to the message.

Although the reply and delete function 102, the reply function 104, and the reply all function 104 are shown and described as being separate buttons, the reply and delete function 102, the reply function 104, and the reply all function 104 may be arranged as a drop down selection. For example, the reply button 104 may be configured such that a drop down menu appears when selected to provide a user additional options of replying to all and replying and deleting when the user moves a cursor over the reply button 104.

The message editor 100 in FIG. 1 may be an internet based message editor associated with an internet based email account provided by GOOGLE®, YAHOO®, MSN®, etc. In other words, the message editor 100 may be a web browser that accesses the Internet based email account operated by a server.

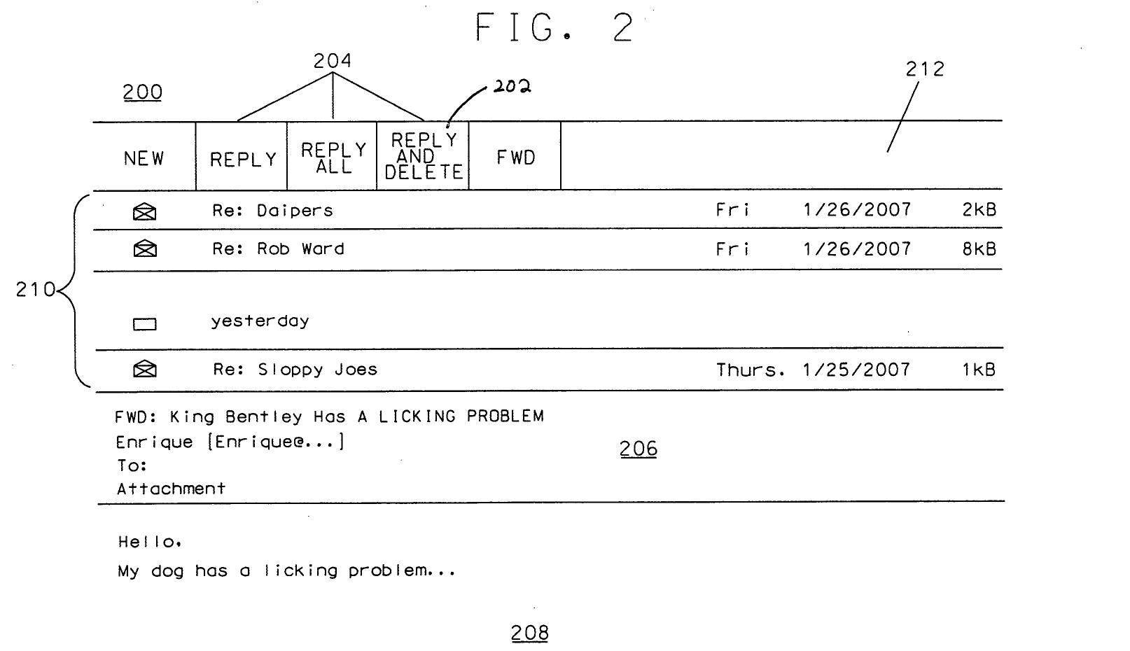

FIG. 2 illustrates an option screen 200 of a message editor according to another embodiment of the present invention. The message editor 200 may be an application based message editor such as MICROSOFT OUTLOOK® or LOTUS NOTES®. In this case, the message editor 200 may include a local email account.

As can be seen in FIG. 2, the option screen of the message editor 200 includes a GUI having a message processing panel 212, an inbox panel 210, a message information panel 206, and a message body 208.

The message information panel 206 and the message body panel 208 may be similar to the message information panel 106 and the message body panel 108 of the message editor 100 in FIG. 1.

The message editor 200 further includes the inbox panel 210 that displays messages in the inbox. A user can select from among the messages displayed in the inbox panel 210. The selected message is then displayed in the body panel 208.

The message processing panel 212 includes a plurality of message processing functions (buttons) 204 (e.g., ‘new’ message, ‘reply’ message, ‘reply all’ message, etc.). The message processing panel 212 further includes a ‘reply and delete’ function (button) 202. The reply and delete function 202 can be selected to compose a reply to the selected message and then automatically delete the selected message from the inbox upon transmission of the reply message. Similarly, although not shown, the message processing panel 212 may include a “forward and delete” function (button) that can be selected to compose a forward message including the selected message and then automatically delete the selected message from the inbox upon transmission of the forward message.

The reply and delete function 202 provides a single command that replies to a selected message and also deletes the selected message. Accordingly, a user need not select two different commands to accomplish both tasks.

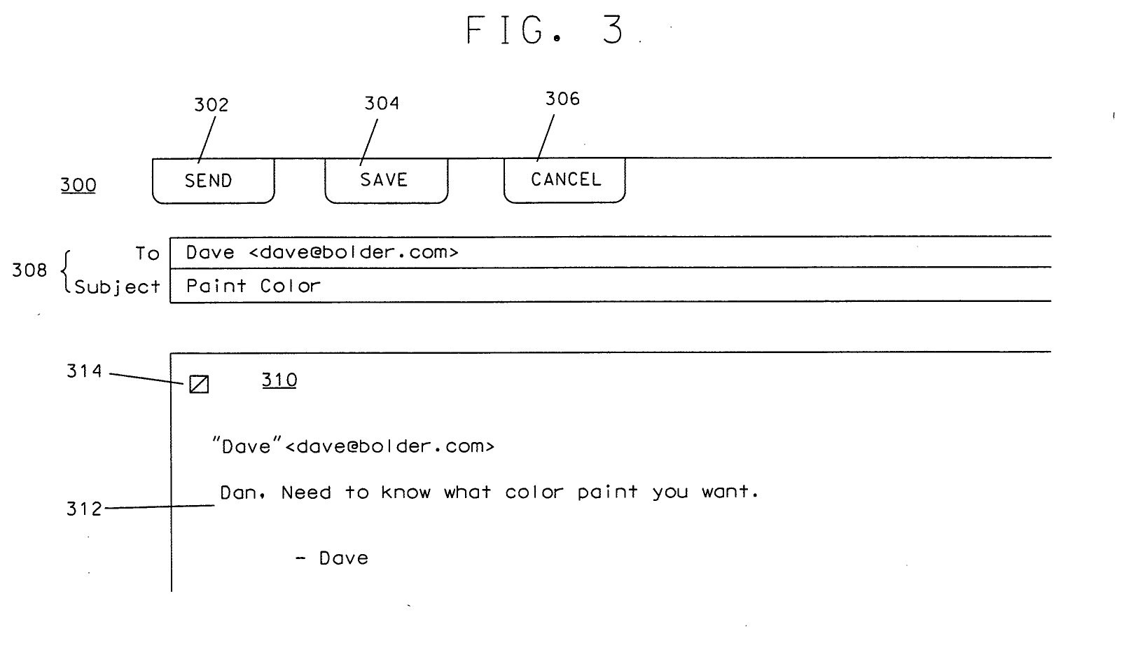

FIG. 3 illustrates an editing screen 300 of a message editor according to an embodiment of the present invention. The editing screen 300 includes a reply message.

The editing screen 300 includes a send function (button) 302, a save function (button) 304, and a cancel function (button) 306. The editing screen 300 further includes a reply message information panel 308 having a destination address (i.e., a recipient address) and subject line. The editing screen 300 also includes a body 310.

The body 310 of the reply message includes previous message text 312, which corresponds to the message being replied to, and a cursor 310 which a user can use to compose the reply message. It should be understood that the previous message text 312 may not necessarily be included in the reply message. That is, the previous message text 312 may be included as an attachment, or not at all.

Once a user completes the reply message, the user can select the send button 302 to transmit the reply message to the recipient address. If the reply and delete function (e.g., the reply and delete function of either FIG. 1 or FIG. 2) was previously selected, the messaging editor 300 transmits the reply message and deletes the original message (i.e., the message being replied to) upon transmission of the reply message. Thus, a user can transmit the reply message while deleting the original message with the selection of a single command.

When an inbox associated with the message editor 300 is stored locally, the message editor 300 can perform both functions (i.e., transmitting and deleting), in response to the selection of the send button 302 (assuming the reply and delete function was selected). On the other hand, when the inbox associated with the message editor 300 is stored on a server, the message editor 300 running at a client can cause the client to instruct the server to perform both the transmission of the reply message and the deletion of the original message, in response to the selection of the send button 302 (assuming that the reply and delete function was selected).

It should be understood that the configuration of the screens 100, 200, and 300 of FIGS. 1-3 are exemplary and are not intended to limit the scope of the present invention.

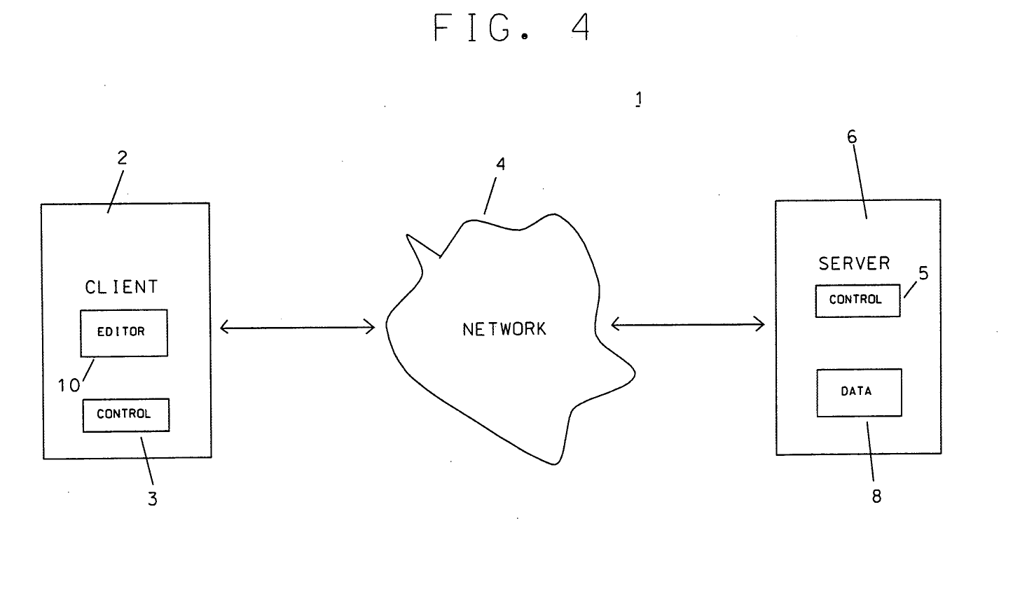

FIG. 4 illustrates a messaging system 1 according to an embodiment of the present invention. The messaging system 1 may be used with a reply and delete function. The messaging system 1 includes a client 2, a network 4, and a server 6.

The client 2 may include a computer terminal having an operating system and a message editor application 10 running thereon. Alternatively, the message editor application 10 may be a web browser application that employs an Internet based messaging application running at the server 6.

The client 2 may include a client control unit 3 (e.g., a CPU or other device) that controls operations performed by the client 2.

The network 4 may be, for example, the Internet, an Intranet, or the World Wide Web.

The server 6 may be a web server or an email server. More particularly, the server 6 may be a SMTP server (Simple Mail Transfer Protocol), a POP3 server (Post Office Protocol 3) or an IMAP server (Internet Mail Access Protocol). The server 6 includes a server control unit 5 and a data storage unit 8.

The client 2 communicates with the server 6 via the network 4 as is known in the art. The client 2 provides commands and/or instructions to the server 6 regarding messaging functions. The data storage unit 8 on the server stores data for a messaging account associated with the client 2. The data storage unit 8 may store data for a plurality of messaging accounts for a plurality of other clients and/or users (not shown).

More particularly, the data storage unit 8 may maintain data associated with an inbox of the message editor application 3 of the client 2. In other words, that data storage unit 8 of the server 6 stores the messages in the inbox of the messaging account associated with the client 2. The client 2 provides instructions to the server 6 to transmit, delete, retrieve, save, etc. messages in the inbox. The data storage unit 8 may be the inbox. Again, although FIG. 4 illustrates that the client 2 includes the message editor application 10, it should be understood that the message editor 10 application may be a web browser enabling access to an internet based messaging application which is actually running on the server 6.

When the message editor application 10 is used by the client 2 to reply to a message, the client can transmit a series of commands and/or instructions (e.g., a select message instruction, a compose reply message instruction, a send message instruction) to the server 6 to open a selected message, compose a reply message, and transmit the reply message from the server 6 to another intended recipient or destination address (not shown) via the network 4.

Specifically, the select message instruction may be sent to the server 6 to open a selected message. For example, in this instruction, the server control unit 5 may access the selected message in the data storage unit 8 and provide the data associated with the selected message to the client 2 for viewing.

The compose reply message instruction may be sent to the server 6 to compose a reply message to the selected message. Once the reply message is composed, the send message instruction may be sent to the server to send the reply message from the server 6 to the intended recipient or destination address (not shown) via the network 4 or from the client 2 to the server 6 and then to the intended recipient or destination address (not shown) via the network 4.

When the message editor application 10 is used by the client 2 to ‘reply and delete’ a message, as described above with reference to FIGS. 1 to 3, the client 2 can transmit a series of commands and/or instructions based on whether the message editor application 10 is running locally at the client 2 or at the server 6 (e.g., a select message instruction, a compose reply message instruction, a send message instruction, and a delete message instruction) to the server 6 to open a selected message, compose a reply message, and transmit the reply message from the server 6 to another recipient or destination address (not shown) via the network 4 while deleting the selected message from the inbox (i.e., stored in the data storage unit 8).

In this case, the additional instruction to delete the selected message is provided to the server 6 by selecting the reply and delete function instead of the reply function. In this manner, a user can select a single command to reply to a message and delete the message to which the reply is being generated.

If the message editor application 10 already has a reply message open, the client 2 may instruct the server 6 to send the reply message and delete the original message with a single instruction.

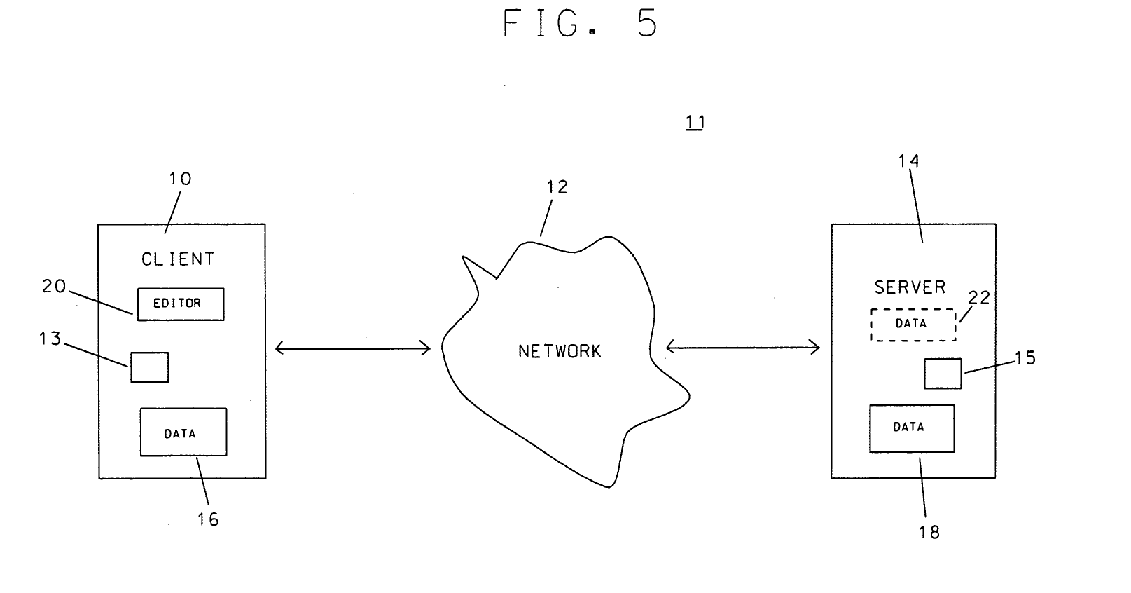

FIG. 5 illustrates a messaging system 11 according to another embodiment of the present invention. The messaging system 11 may be used with a reply and delete function.

The messaging system 11 includes a client 10 and a server 14. The client 10 and the server 14 may be similar in most respects to the client 2 and the server 6 shown in FIG. 4.

In this case, however, the client 10 includes a message editor 20 and a local data storage unit 16. The local data storage unit 16 can include an inbox having messages for a messaging account associated with the client 10. Alternatively, the local data storage unit 16 may include copies of the messages in the inbox, for example, in a cache memory if the inbox is actually stored on the server 14.

The server 14 may include more than one data storage unit 18 and 22 for storing inboxes from various messaging accounts.

Upon receiving a send command in the message editor 20, the client 10 transmits a reply message to a destination address via network 12 or instructs the server 14 to transmit the reply message to the destination address via the network 12.

When the reply and delete function is used in the messaging system 11, the client 10 locally deletes the selected message being replied to (if the selected message is stored in the data storage unit 16) and/or instructs the server 14 to remotely delete the selected message being replied to (if the selected message is stored in one of the data storage units 18 and 22). This operation is performed during or upon transmission of the reply message.

A client control unit 13 controls operation of the client 10, and a server control unit 15 controls operation of the server 14.

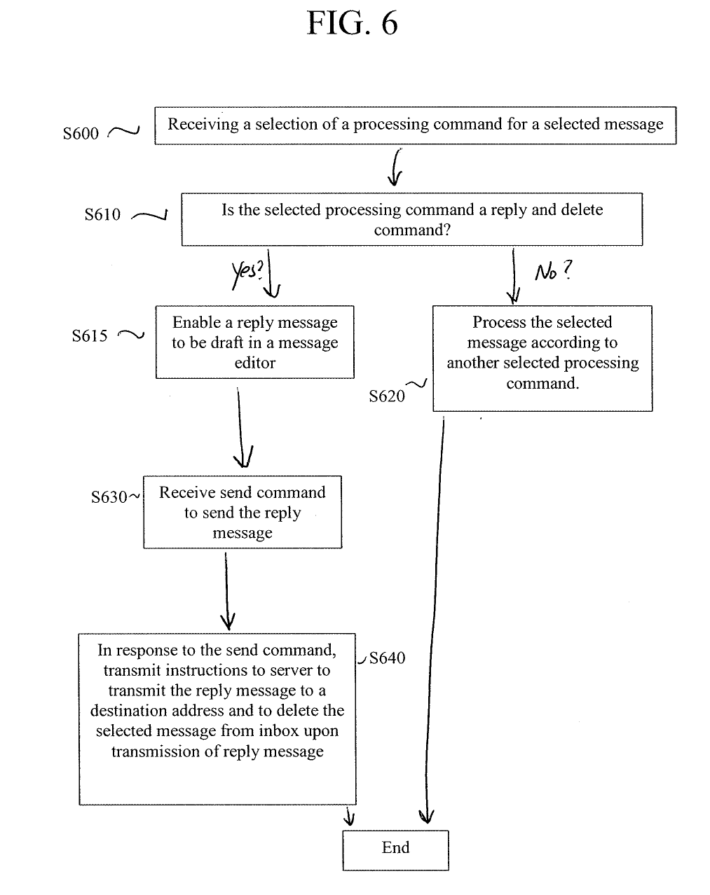

FIG. 6 illustrates a method of managing messages in a messaging system according to an embodiment of the present invention. The method of FIG. 6 includes operation S600 of receiving a selection of a processing command for a selected message. In operation S610, it is determined whether the selected processing command is a ‘reply and delete’ command. If the operation S610 determines that the selected processing command is the reply and delete command, a message editor enables a reply message to be composed at operation S615. At operation S630, once the reply message is composed, the message editor enables a send command to be selected. In response to the send command being selected, the message editor instructs a server to transmit the reply message to an intended address and to delete the selected message from an inbox upon transmission of the reply message.

If on the other hand, the operation S610 determines that the selected processing command is not the reply and delete command, the message editor processes the selected message according to another selected processing command at operation S620.

The method of FIG. 6 may be performed using the message editor 100 of FIG. 1, the message editor 200 of FIG. 2, and/or the message editor 300 of FIG. 3. Additionally, the method of FIG. 6 may be performed by the messaging system 1 of FIG. 4 and/or the messaging system 11 of FIG. 5.

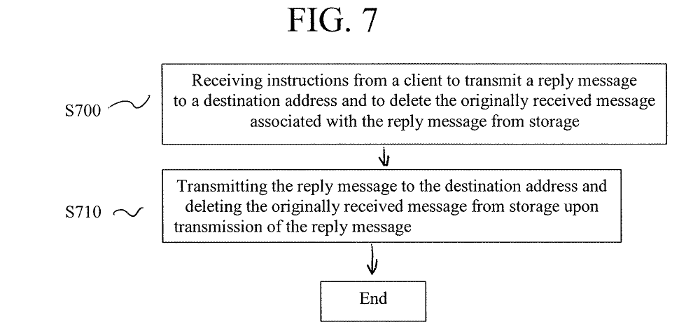

FIG. 7 illustrates a method of managing messages in a messaging system according to another embodiment of the present invention. In operation S700, an instruction to transmit a reply message to a destination address and to delete an originally received message associated with the reply message (i.e., the message being replied to) is received. In this case, these two instructions may be received in response to a single command. At operation S710, in response to the instruction, the reply message is transmitted to the destination address and the originally received message associated with the reply message is deleted from storage. The method of FIG. 7 may be performed by a server, in response to instructions from a client.

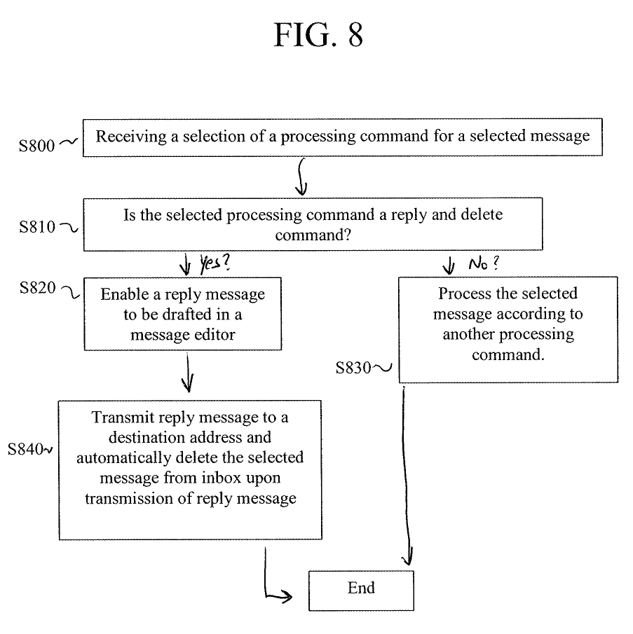

FIG. 8 illustrates a method of managing messages in a messaging system according to yet another embodiment of the present invention.

The method of FIG. 8 includes operation S800 of receiving a selection of a processing command for a selected message. In operation S810, it is determined whether the selected processing command is a ‘reply and delete’ command. If the operation S810 determines that the selected processing command is the reply and delete command, a message editor enables a reply message to be composed at operation S820. Once the reply message is composed, the reply message is transmitted to an intended address and the selected message is automatically deleted from an inbox upon transmission of the reply message at operation S840.

If on the other hand, the operation S810 determines that the selected processing command is not the reply and delete command, the message editor processes the selected message according to another selected processing command at operation S830.

The method of FIG. 8 may be performed using the message editor 100 of FIG. 1, the message editor of FIG. 2, and/or the message editor of FIG. 3. Additionally, the method of FIG. 8 may be performed by the messaging system 1 of FIG. 4 and/or the messaging system 111 of FIG. 5.

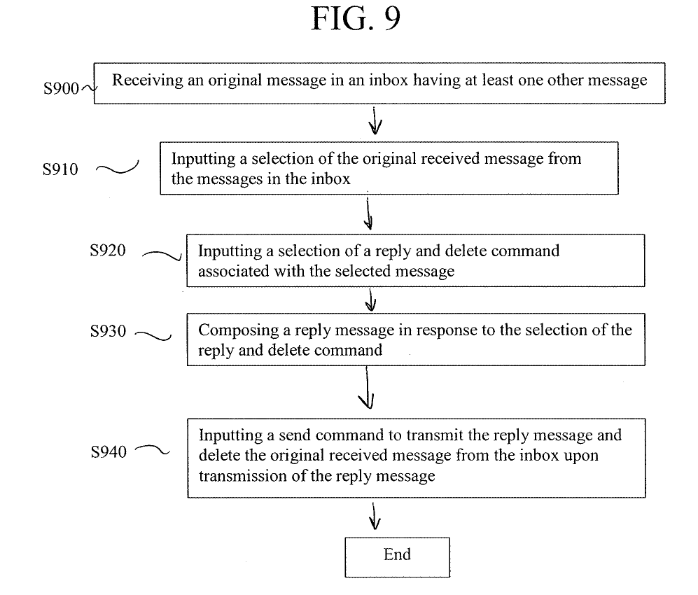

FIG. 9 illustrates a method of using a reply and delete function according to an embodiment of the present invention.

In operation S900, an original message is received in an inbox having at least one other message. A selection of the original message is received at operation S910. A selection of the reply and delete function is received for the selected message at operation S920. In operation S930, a reply message is composed in response to the selection of the reply and delete command. In operation S940, a send command is input to transmit the reply message to a destination address and to delete the original message from an inbox upon transmission of the reply message.

The invention can be embodied as computer readable codes on a computer readable recording medium. The computer readable recording medium may be any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present general inventive concept can be easily construed by programmers skilled in the art to which the present general inventive concept pertains. For example, the message editors, methods, client control units, and/or server control units described above may be implemented in software.

Although a few embodiments of the present invention have been shown and described, it will be appreciated by those skilled in the art that changes may be made in these embodiments without departing from the principles and spirit of the invention, the scope of which is defined in the appended claims and their equivalents

I claim:

1. A messaging system, comprising:
an electronic mail messaging application having a reply and delete function; and
a data storage having an inbox associated with the electronic mail messaging application, the inbox having at least one email stored therein,
wherein the reply and delete function composes a reply message to the at least one email and deletes the at least one email from the inbox automatically when the reply message is sent.

2. The messaging system of claim 1, wherein the electronic mail messaging application further comprises a reply function and a reply to all function.

3. The messaging system of claim 1, wherein the data storage is located at a server.

4. The messaging system of claim 1, wherein the electronic mail messaging application is an internet-based email application.

5. The messaging system of claim 1, further comprising:
a client device having the electronic mail messaging application running thereon; and
a server having the inbox with a plurality of messages.

6. The messaging system of claim 1, wherein the electronic mail messaging application enables a message to be selected from the inbox, enables the reply and delete function to be selected for the selected message, enables a reply message to the selected message to be composed, and enables a send command to be selected to transmit the reply message and delete the selected message from the inbox.

7. A messaging system, comprising:
a server in communication with at least one client; and
an email application with at least one email stored in an inbox located on server,
wherein the email application includes a reply and delete function to compose a reply to a selected message and to delete the selected message when the reply is transmitted.

8. The messaging system of claim 7, wherein the email application is accessible via a web browser operating at the client.

9. The messaging system of claim 7, wherein the email application further includes a reply function, a reply to all function, and a delete function.

10. The messaging system of claim 7, wherein the reply and delete function is selectable to compose the reply to the selected message in the inbox, to enable the reply to be sent, and to delete the selected message from the inbox automatically when the reply is sent.

11. A messaging system, comprising:
a client device in communication with a server; and
a message editor running on the client device, the message editor providing instructions to the server and presenting a graphical user interface having a reply and delete function which creates a reply to a selected message and deletes the selected message upon transmission of the reply.

12. The messaging system of claim 1 wherein the message editor comprises a web browser.

13. The messaging system of claim 1 wherein the message editor presents a first graphical user interface to enable selection of one of a plurality of messages, presents a second graphical user interface in response to the selection of the message to enable a selection of a processing function for the selected message, and presents a third graphical user interface in response to the selection of the processing function to enable a reply message to be composed when the selected processing function is a reply function, the third graphical user interface having a send function which is selectable to send the reply message and delete the selected message when the reply function is the reply and delete function.
